(19) United States
(12) Patent Application Publication
(10) Pub. No.: US 2026/0004631 A1
(43) Pub. Date: Jan. 1, 2026

(54) GAMING MACHINE

(71) Applicant: VEIKKAUS OY, Helsinki (FI)

(72) Inventor: Jukka LEHTONEN, Vantaa (FI)

(21) Appl. No.: 18/881,131

(22) PCT Filed: Jun. 20, 2023
(86) PCT No.: PCT/FI2023/050367

§ 371 Date: Jan. 3, 2025

(30) Foreign Application Priority Data
Jul. 4, 2022 (FI) 20225628

(51) Int. Cl. G07F 17/32; G06F 1/20

(52) U.S. Cl. CPC G07F 17/3216; G06F 1/20

(57) ABSTRACT

The gaming machine includes a housing, a processor space arranged within the housing and accommodating at least one processing unit of the gaming machine, a cooling space arranged within the housing, the cooling space including at least one inlet opening for introducing air from the processor space into the cooling space and at least one outlet opening for introducing air that has cooled down in the cooling space back into the processor space. The cooling space is delimited by a cooling wall that is configured to dissipate heat from the cooling space to the outside of the cooling space, and the gaming machine is configured such that air introduced from the processor space into the cooling space flows in contact with the cooling wall before returning into the processor space.

### TECHNICAL FIELD OF THE INVENTION

The present invention relates to a gaming machine, as defined in claim 1.

### BACKGROUND OF THE INVENTION

Different gaming machines, sometimes referred to as electronic gaming machines (EGM), are a popular form of entertainment. Gaming machines can be placed in casinos or gambling halls that are dedicated to gambling, but also in grocery stores, gas stations, restaurants and other places.

Lots of different kind of gaming machines are known. The operation of most gaming machines is nowadays based on software running on a computer, which allows offering in a single gaming machine several different gaming options to a user, or updating the machine from time to time.

The control electronics of the gaming machine and especially the central processing unit (CPU) produces a lot of heat. If the electronic components of the gaming machine are not cooled down effectively, the operation of the gaming machine may be disturbed and the lifetime of the components may be shortened.

A conventional way of cooling down the electronic components of a gaming machine is to provide the gaming machine with ventilation apertures and fans that discharge warm air from the housing of the gaming machine and supply cooler ambient air into the housing. A drawback of such an arrangement is that with the ambient air dust and other impurities can enter the housing of the gaming machine. The dust impairs functioning of the electronics and other components of the gaming machine. The dust problem has been addressed by providing the gaming machines with air filters, but the air filters make the construction more complicated and require regular service.

### SUMMARY OF THE INVENTION

An object of the present invention is to provide an improved gaming machine. The characterizing features of the gaming machine according to the invention are defined in claim 1.

The gaming machine according to the invention comprises a housing, a processor space arranged within the housing and accommodating at least one processing unit of the gaming machine, a cooling space arranged within the housing, the cooling space comprising at least one inlet opening for introducing air from the processor space into the cooling space and at least one outlet opening for introducing air that has cooled down in the cooling space back into the processor space, wherein the cooling space is delimited by a cooling wall that is configured to dissipate heat from the cooling space to the outside of the cooling space, and the gaming machine is configured such that air introduced from the processor space into the cooling space flows in contact with the cooling wall before returning into the processor space.

By providing the gaming machine with a cooling space, warm air from the processor space is not discharged outside of the housing of the gaming machine, but the air is circulated within the housing. This prevents dust from entering the processor space and also removes the need for air filters. The maintenance of the gaming machine is thus simplified and the reliability and life cycle of the gaming machine are increased.

According to an embodiment of the invention, the cooling space is configured such that the length of the flow path of air from the at least one inlet opening to the at least one outlet opening is at least 70 percent of the height of the gaming machine. This ensures effective cooling of the air. The air can flow in a single direction, or the cooling space can be configured to guide the air flow such that the required length of the flow path can be achieved even with a smaller height of the cooling space. The length of the flow path can be affected by the size of the cooling wall and elements guiding the air flow in the cooling space. The suitable length of the flow path depends for example on the needed cooling power and the properties of the cooling wall. For instance, if the thermal conductivity of the cooling wall is very high, the flow path can be shorter.

According to an embodiment of the invention, at least part of the cooling wall forms a portion of an outer wall of the gaming machine. By arranging at least part of the cooling wall as a portion of the outer wall, effective cooling is ensured.

According to an embodiment of the invention, the cooling wall forms at least 35 percent of the rear wall of the gaming machine. This provides a large cooling surface for the cooling space. Alternatively, the cooling wall could form a similar portion of a side wall of the gaming machine. The gaming machine could also have, for instance, a circular shape or some other non-rectangular shape. The cooling wall could form at least 10 percent of the wall area of the housing of the gaming machine. The size required from the cooling wall depends on various factors, such as the needed cooling power and the heat transfer properties of the cooling wall.

According to an embodiment of the invention, the cooling wall is made of a material with a high thermal conductivity. According to an embodiment of the invention, the cooling wall is made of a material having a thermal conductivity of at least 80 W/(m·K), preferably at least 150 W/(m·K) at atmospheric pressure and temperature of 20° C. By making the cooling wall of a material with a high thermal conductivity, effective cooling of the air in the cooling space is ensured.

According to an embodiment of the invention, the cooling wall is made of aluminum or aluminum alloy. Aluminum and aluminum alloys provide a high thermal conductivity.

According to an embodiment of the invention, the cooling space is configured for air circulation by gravity. Cooling fans are thus not necessary, and the effect of possible cooling fans is boosted by gravitational air circulation.

According to an embodiment of the invention, the at least one inlet opening of the cooling space is arranged in the vertical direction above the at least one outlet opening. Hot air thus enters an upper part of the cooling space and after cooling down, the air exits the cooling space from a lower part of the cooling space. This facilitates effective air flow in the cooling space.

According to an embodiment of the invention, the gaming machine comprises a partition wall separating the cooling space from another part of the interior of the housing and a power source is attached to the partition wall outside of the cooling space. Heat from the power source can thus be conducted via the partition wall to the cooling space.

According to an embodiment of the invention, the partition wall is provided with an opening and the power source is attached to the wall by means of a mounting plate comprising cooling fins on the cooling space side of the mounting plate to dissipate heat into the air in the cooling space. This improves the heat dissipation from the power source to the cooling space.

According to an embodiment of the invention, the gaming machine comprises at least one cooling fan that is configured to introduce air into the cooling space. According to an embodiment of the invention, the gaming machine comprises at least one cooling fan that is configured to discharge air from the cooling space. With the cooling fans, air flow from the processor space into the cooling space and air circulation in the cooling space can be enhanced.

According to an embodiment of the invention, the at least one cooling fan is thermostat-controlled. The cooling wall and gravitational flow may in many cases provide a sufficient cooling power, and the cooling fans can thus be operated according to the need to save power.

According to an embodiment of the invention, the gaming machine comprises one or more guide elements configured to guide air flow in the cooling space. The one or more guide elements ensure that the warm air from the processor space is sufficiently cooled down before returning into the processor space.

According to an embodiment of the invention, said one or more guide elements are configured to divide the cooling space into at least two compartments to increase the length of the flow path of air between the inlet opening and the outlet opening. This allows utilizing even a cooling wall with a smaller surface area effectively. The guide elements can be configured to guide the air to flow for example both downwards and upwards before the air is returned to the processor space.

According to an embodiment of the invention, the gaming machine comprises at least one support rail connecting the cooling wall of the cooling space to a parallel partition wall separating the cooling space from another part of the interior of the gaming machine. The support rail stiffens the structure of the housing and can also conduct heat to the cooling wall.

### BRIEF DESCRIPTION OF THE DRAWINGS

Embodiments of the invention are described below in more detail with reference to the accompanying drawings, in which

FIG. 1 shows a perspective rear view of a lower part of a gaming machine according to an embodiment of the invention,

FIG. 2 shows a similar view as FIG. 1 but a rear wall of the gaming machine removed,

FIG. 3 shows a front view of the lower part of the gaming machine of FIGS. 1 and 2,

FIG. 4 shows a partial cross-sectional view taken along line A-A of FIG. 4,

FIG. 5 shows a partial cross-sectional view taken along line B-B of FIG. 5,

FIG. 6 shows a partial cross-sectional view taken along line C-C of FIG. 5,

FIG. 7 shows a front view of a gaming machine according to another embodiment of the invention,

FIG. 8 shows a cross-sectional view taken along line D-D of FIG. 7,

FIG. 9 shows a perspective rear view of the gaming machine of FIG. 7,

FIG. 10 shows a similar view as FIG. 9 but parts of the gaming machine removed,

FIG. 11 shows an enlarged view of detail A of FIG. 8,

FIG. 12 shows a cross-sectional view taken along line E-E of FIG. 7,

FIG. 13 shows a perspective rear view of a gaming machine according to a further embodiment of the invention,

FIG. 14 shows a similar view as FIG. 13 but parts of the gaming machine removed,

FIG. 15 show an enlarged view of detail B of FIG. 14, and

FIG. 16 shows a perspective front view of the gaming machine of FIG. 13 parts of the gaming machine removed.

### DETAILED DESCRIPTION OF EMBODIMENTS OF THE INVENTION

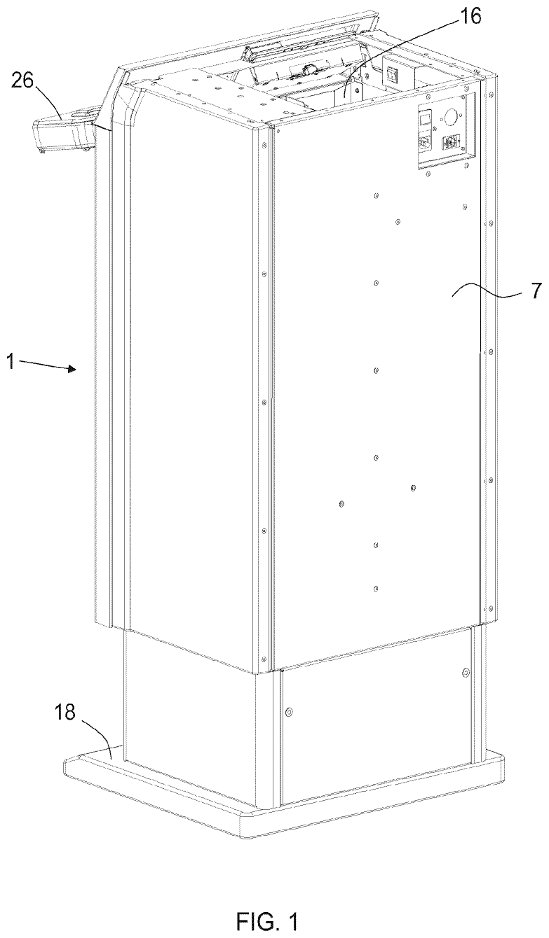

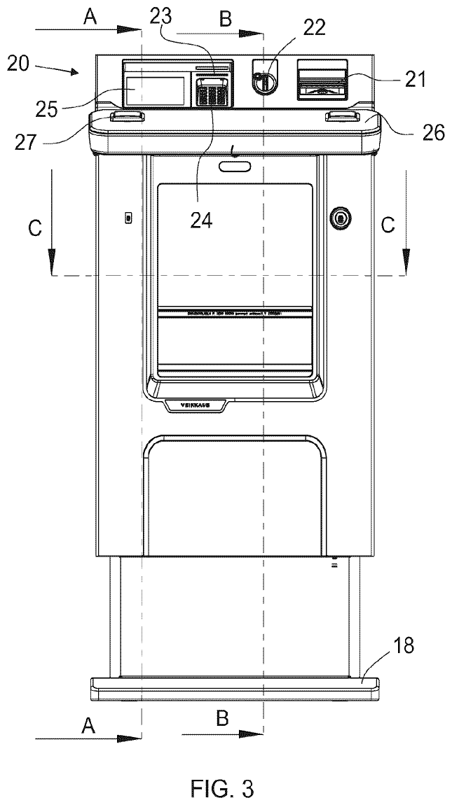

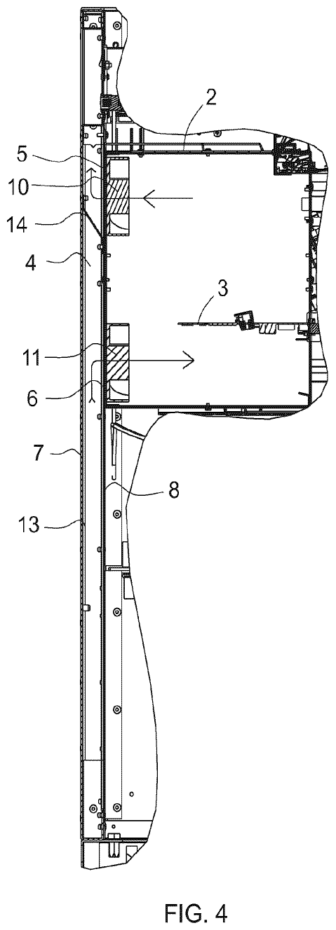

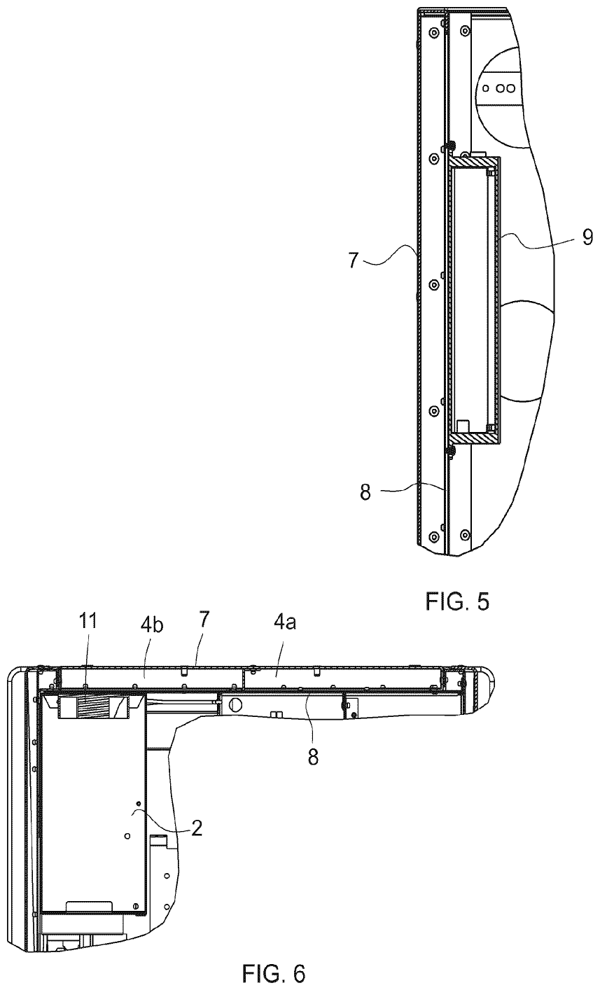

FIGS. 1 to 3 show different views of a lower part of a gaming machine according to an embodiment of the invention. Details of the gaming machine can be seen in the cross-sectional views of FIGS. 4 to 6. The gaming machine is configured for playing games of change, such as different card games or slot machine type games.

The gaming machine comprises a payment terminal 20, via which the user of the gaming machine can pay for the played games. In the example of FIGS. 1 to 3, the payment terminal 20 comprises a slot 21 for banknotes, a coin slot 22 and a card reader 23. The payment terminal 20 further comprises a keypad 24, for instance for inputting a pin code of a debit or credit card, and a display 25. The payment terminal 20 does not need to comprise all the features listed above, but the available payment methods could be limited. Also, the payments could be implemented for example via bank transfers carried out using a keyboard or a touch display of the gaming machine or using a mobile device of the user of the gaming machine. The payment terminal 20 is thus not an essential part of the gaming machine.

The gaming machine further comprises a push-button panel 26. In the example of FIGS. 1 to 3, the push-button panel 26 comprises two push-buttons 27. However, the push-button panel 26 could comprise a single push-button 27 or more than two push-buttons 27. The games provided in the gaming machine can be played using the one or more push-buttons. However, it is possible to configure the gaming machine such that only some games are played using the push-buttons 27 arranged in the push-button panel 26 and/or that the games are played only partly using the push-buttons 27 of the push-button panel 26. The gaming machine could comprise further push-button panels and/or some functions of the gaming machine could be used via a touch display or other input means.

In addition to the parts shown in the figures, the gaming machine further comprises a display, on which the games that can be played are displayed. Instead of, or in addition to the display, the gaming machine could comprise electromechanical components, such as rotating wheels that are used for implementing the games.

The gaming machine is configured to be mounted on a floor. The gaming machine comprises a base 18 that is configured to support the gaming machine on the floor. The gaming machine has a front side, which is configured to face the user of the gaming machine. A rear side of the gaming machine faces an opposite direction. The gaming machine has two sides extending between the front side and the rear side. The direction parallel to the front and rear sides is a lateral direction.

The gaming machine comprises a housing 1. The housing 1 defines an interior space 16 of the gaming machine. The interior space 16 is divided into at least two sub-spaces.

The housing 1 is configured to accommodate various components of the gaming machine. The gaming machine comprises various electronic components that are needed for the operation of the gaming machine. Some electronic components of the gaming machine, such as the parts of the display, are located outside of the housing 1 shown in FIGS. 1 to 3, but many electronic components are located inside the housing. The gaming machine comprises at least one processing unit (processor). The processor is configured to perform operations specified in one or more computer programs to operate the functions of the gaming machine. The processors of the gaming machine can comprise one or more central processing units (CPUs), a graphics processing unit (GPU) and/or a processing unit combining the functions of a CPU and a GPU.

The gaming machine comprises a processor space 2 that is arranged within the housing 1. The processor space 2 accommodates at least one processing unit 3 of the gaming machine, such as a CPU. The same processor space 2 could accommodate also possible further processing units of the gaming machine. The processor space 2 can also accommodate other electronic components of the gaming machine.

The gaming machine further comprises a cooling space 4 arranged within the housing 1. The cooling space 4 comprises at least one inlet opening 5 for introducing air from the processor space 2 into the cooling space 4 and at least one outlet opening 6 for introducing air that has been cooled down in the cooling space 4 back into the processor space 2.

The cooling space 4 is delimited by a cooling wall 7 that is configured to dissipate heat from the cooling space 4 to the outside of the cooling space 4. The gaming machine is configured such that air introduced from the processor space 2 into the cooling space 4 flows in contact with the cooling wall 7 before returning into the processor space 2.

The gaming machine is thus configured for closed circulation of cooling air. Especially the CPU and other processors generate a lot of heat when being operated. The air heated in the processor space 2 flows through the inlet opening 5 of the cooling space 4 into the cooling space 4. In the cooling space 4, the air flows in contact with the cooling wall 7 and heat is transferred from the air to the cooling wall 7 and further conducted and radiated to air on the other side of the cooling wall 7. The air that has cooled down in the cooling space 4 can then flow through the outlet opening 6 of the cooling space 4 back into the processor space 2.

The cooling space 4 and the processor space 2 are part of a substantially dustproof volume of the gaming machine. As the air is circulated within the dustproof volume, the processing units 3 and other electronic components of the gaming machine located in the processor space 2 are protected from dust. The cooling space 4 and the processor space 2 are also configured to prevent any significant air flow to the outside of the housing 1 of the gaming machine. The combined volume of the cooling space 4 and the processor space 2 does not need to be completely airproof. It is thus not necessary to seal the joints of the housing 1, but nor is the housing 1 provided with any openings allowing flow into or out of the closed volume, which the cooling space 4 and the processor space 2 form part of.

The whole housing 1 of the gaming machine can be made dustproof. However, that is not necessary, but it is sufficient that the volume configured for the closed air circulation of the processor space 2 and the cooling space 4 is dustproof.

In the embodiment of FIGS. 1 to 6, the air flows from the processor space 2 directly into the cooling space 4 and from the cooling space 4 directly into the processor space 2. The cooling air circulates thus solely in the cooling space 4 and processor space 2. However, there could be also further spaces included in the closed air circulation.

In the embodiment of FIGS. 1 to 6, the cooling wall 7 forms a portion of an outer wall of the gaming machine. Heat is thus conducted and radiated from the cooling wall 7 directly to the ambient air around the gaming machine. This ensures that the cooling space 4 can effectively cool down the air circulated from the processor space 2 into the cooling space 4. However, the gaming machine could comprise further structures on the outer side or the cooling wall 7. Even a further space could be formed on the outer side of the cooling wall 7. The further space could be configured to receive ambient air for cooling. Alternatively, the space could be a closed space with cooling means for transferring heat to the outside of the gaming machine.

In the embodiment of FIGS. 1 to 6, the cooling wall 7 forms part of the rear wall of the gaming machine. The cooling wall 7 forms a major part of the rear wall of the gaming machine, thus ensuring effective cooling. It is advantageous to configure the cooling wall 7 to form at least 35 percent of the rear wall of the gaming machine. In the embodiment of FIGS. 1 to 6, the cooling wall 7 extends in the lateral direction substantially over the whole width of the gaming machine.

In the embodiment of FIGS. 1 to 6, the housing 1 of the gaming machine has a substantially rectangular shape seen in the vertical direction. In a gaming machine with a rectangular cross-sectional profile, the cooling space 4 could be arranged such that the cooling wall 7 forms part of a side wall of the gaming machine. The cooling wall 7 could thus form at least 35 percent of one of the side walls of the gaming machine, or a major part of the side wall.

The gaming machine could also have some other shape. For instance, the cross-sectional profile could be circular. Regardless of the cross-sectional profile of the housing 1, the cooling wall 7 could be configured to form a certain portion of the outer wall of the housing 1 of the gaming machine. For instance, the cooling wall 7 could be configured to form at least 10 percent of the outer wall of the housing 1.

It should be noted that the cooling wall 7 does not need to be planar. The cooling wall 7 could be curved, or the cooling wall 7 could be formed of two or more portions which are arranged at some other angle relative to each other than 180 degrees. For instance, the cross-sectional profile of the housing 1 could be hexagonal or octagonal and the cooling wall 7 could form part of two or more faces of the housing 1.

The cooling wall 7 is made of a material with a high thermal conductivity. The thermal conductivity of the material of the cooling wall 7 can be, for instance, at least 80 W/(m·K), preferably at least 150 W/(m·K) at atmospheric pressure and temperature of 20° C. More preferably, the thermal conductivity is at least 200 W/(m·K) at atmospheric pressure and temperature of 20° C. The cooling wall 7 can be made of, for instance, aluminum or an aluminum alloy, which provide a good thermal conductivity and sufficient strength for the cooling wall 7, allowing it to form part of the outer surface of the gaming machine. The cooling wall can be made of anodized aluminum.

In the embodiment of FIGS. 1 to 6, the cooling wall 7 has a flat outer surface. Because of the good thermal conductivity and large surface area of the cooling wall 7, even a flat surface can provide effective cooling. However, the outer surface of the cooling wall 7 could be provided with cooling fins to further enhance the dissipation of heat.

The gaming machine comprises a partition wall 8 that is configured to separate the cooling space 4 from another part of the interior 16 of the housing 1 of the gaming machine. The partition wall 8 separates the cooling space 4 also from the processor space 2. In the embodiment of FIGS. 1 to 6, the partition wall 8 is parallel to the direction of the cooling wall 7. The partition wall 8 extends in the lateral direction of the gaming machine substantially over the whole width of the gaming machine. The cooling space 4 is formed between the cooling wall 7, the partition wall 8 and portions of the side walls of the gaming machine.

The partition wall 8 does not need to be parallel with the cooling wall 7. In particular, if the cooling wall 7 is not planar, the partition wall 8 and the cooling wall 7 could have different shapes. For instance, the partition wall 8 could be planar and the cooling wall 7 could be curved or comprise two or more portions arranged at an angle relative to each other.

The partition wall 8 can be made of, for instance, steel, such as galvanized steel. However, the partition wall 8 could also be made of aluminum or an aluminum alloy.

In the embodiment of FIGS. 1 to 6, the processor space 2 is a CPU housing. The CPU housing 2 is attached to the partition wall 8. The CPU housing 2 and the partition wall 8 comprise openings forming the inlet 5 and the outlet 6 of the cooling space 4. The CPU housing 2 is provided with two cooling fans 10, 11. A first cooling fan 10 is configured to blow air from the CPU housing 2 through the inlet opening 5 of the cooling space 4 into the cooling space 4. A second cooling fan 11 is configured to draw air from the cooling space 4 through the outlet opening 6 of the cooling space 4 into the CPU housing 2. The inlet opening 5 of the cooling space 4 is arranged above the outlet opening 6 of the cooling space 4.

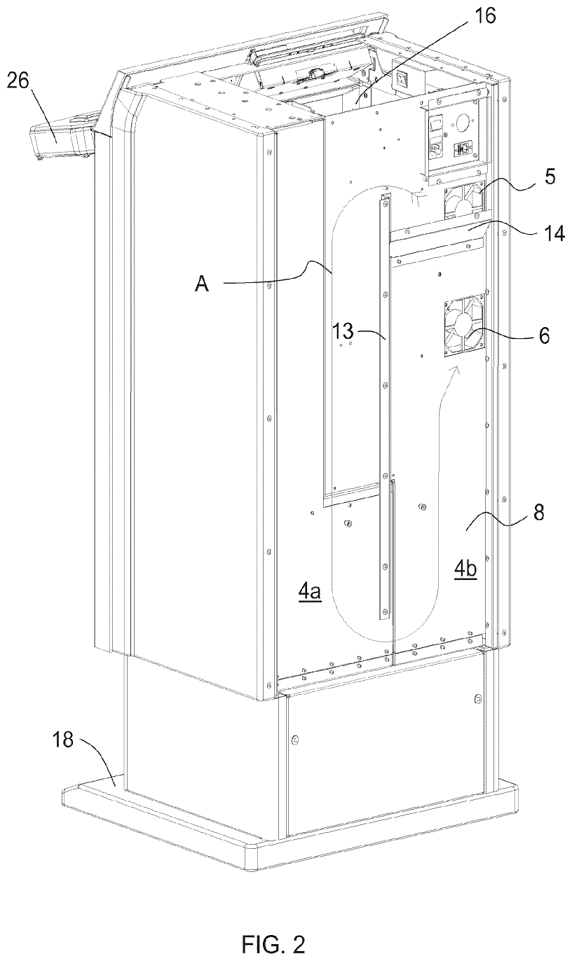

The cooling space 4 is provided with guide elements 13, 14 that are configured to guide air flow in the cooling space 4. The guide elements 13, 14 extend from the partition wall 8 to the cooling wall 7. A first guide element 13 extends in the vertical direction of the cooling space 4 and divides the cooling space 4 into a first compartment 4a and a second compartment 4b. The first compartment 4a and the second compartment 4b are in fluid communication with each other in the lower part of the cooling space 4. A second guide element 14 is arranged between the inlet opening 5 and the outlet opening 6 of the cooling space 4. The second guide element 14 extends from the first guide element 13 to a side wall of the cooling space 4. When air is introduced into the cooling space 4 via the inlet opening 5, the second guide element 14 prevents the air from flowing directly to the outlet opening 6. The air flows in the direction of arrow A shown in FIG. 2 downwards in the first compartment 4a. At the lower end of the cooling space 4, the air flows into the second compartment 4b and in the second compartment 4b upwards to the outlet opening 6 of the cooling space 4. The second cooling fan 11 draws the air into the CPU space 2.

In the embodiment of FIGS. 1 to 6, the air flows in contact with the cooling wall 7 first downwards and then upwards. The length of the flow path of the cooling air is longer than the height of the cooling space 4. The air is thus in contact with the cooling wall 7 for a long time, which ensures effective cooling.

The cooling space 4 and the guide elements 13, 14 could also be configured in many other different ways. For instance, the cooling space 4 could be divided into two or more compartments by means of one or more horizontal guide elements. Air could thus be arranged to flow in the cooling space 4 from one side of the gaming machine to the opposite side in one compartment and then in another compartment to the opposite direction.

In the embodiment of FIGS. 1 to 6, the cooling fans 10, 11 boost the air flow. However, even without the cooling fans 10, 11, the air would flow by gravity.

The hot air is introduced into the cooling space 4 through the upper end of the cooling space 4, and as the air cools down and its density increases, it flows towards the lower end of the cooling space 4. Depending on the required cooling effect, an arrangement similar to the arrangement of FIGS. 1 to 6 could be used even without the cooling fans 10, 11 or with a single cooling fan. The cooling fans 10, 11 could also be thermostat-controlled and operated only when the temperature of for example a processing unit arranged in the processor space 2 or air temperature in the processor space 2 exceeds a predetermined threshold.

In the embodiment of FIGS. 1 to 6, the gaming machine comprises a power source 9. The power source 9 can power one or more processors 3 arranged in the processor space 2 and/or other electronic components of the gaming machine. The power source 9 is attached to the partition wall 8 outside of the cooling space 4. Heat produced by the power source 9 is thus conducted to the partition wall 8 and further into the cooling space 4. If the dissipation of heat from the power source 9 is not effective enough with the arrangement of the figures, the partition wall 8 can be provided with an opening and the power source 9 can be attached to the wall 8 by means of a mounting plate comprising cooling fins on the cooling space side of the mounting plate to dissipate heat into the air in the cooling space 4.

In the embodiment of FIGS. 1 to 6, the cooling space 4 is arranged in a rear part of the housing 1 of the gaming machine. However, the cooling space 4 could be arranged in a similar way on one of the sides of the gaming machine.

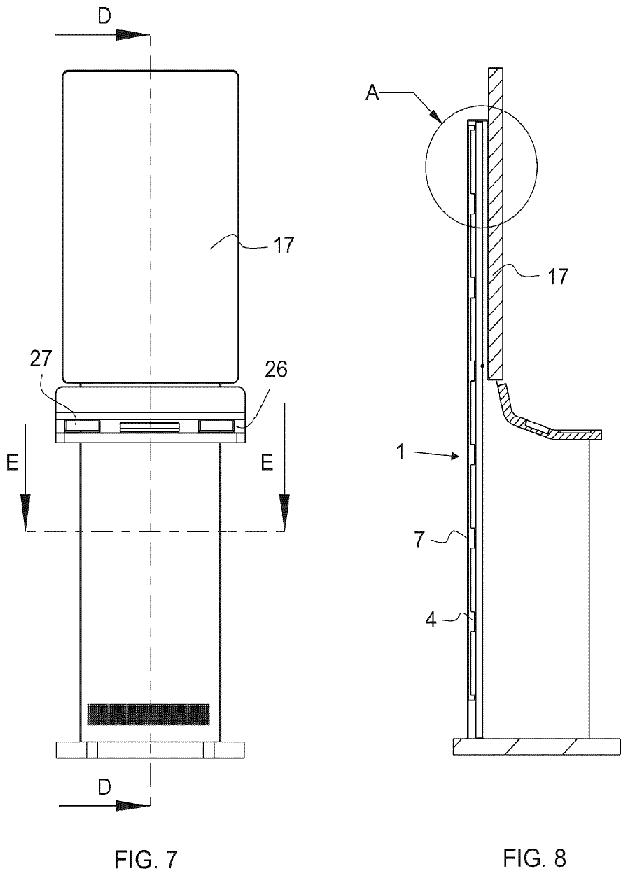

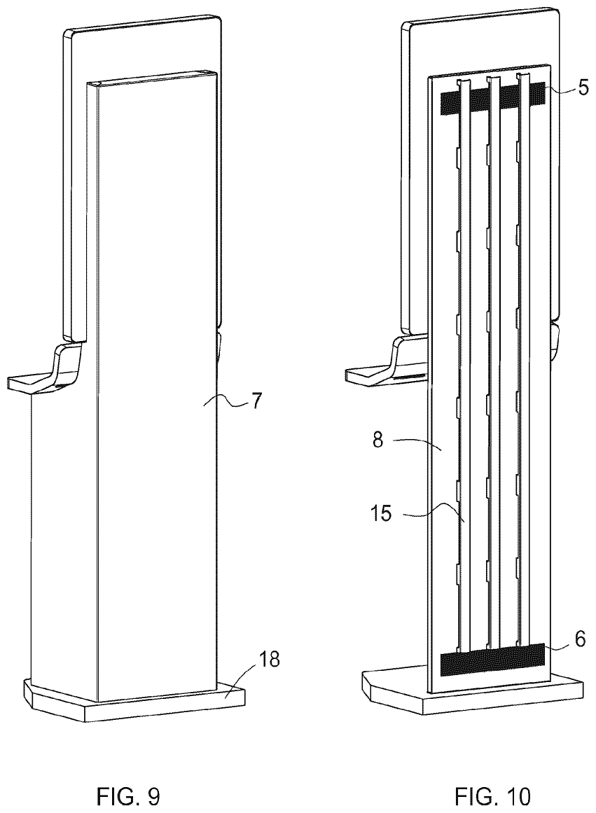

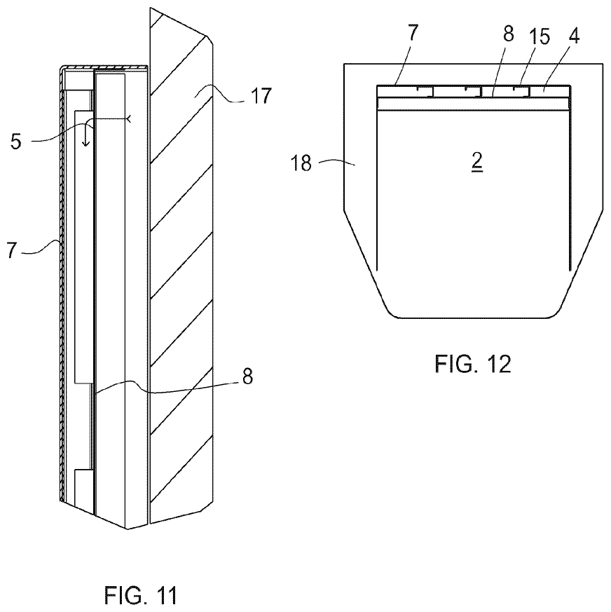

FIGS. 7 to 12 show a gaming machine according to another embodiment of the invention. In FIGS. 7 and 8, also a display 17 of the gaming machine is shown. The design of the gaming machine of FIGS. 7 to 12 differs from the gaming machine of FIGS. 1 to 6, but the functioning of the gaming machines can be similar. FIGS. 7 and 8 show a push-button panel 26 with push-buttons 27, but the gaming machine could comprise also different means for playing the games. A payment terminal is not shown, but the gaming machine could comprise a similar payment terminal as the gaming machine of FIGS. 1 to 6.

Although FIGS. 7 to 12 do not show all the details of the gaming machine, the gaming machine comprises a processor space 2, cooling space 4, cooling wall 7 and an inlet opening 5 and an outlet opening 6 of the cooling space 4. The gaming machine also comprises a partition wall 8, which delimits the cooling space 4 opposite to the cooling wall 7. In the embodiment of FIGS. 7 to 12, the housing 1 of the gaming machine extends to an area behind the display 17. Also the cooling space 4 extends behind the display 17 to an upper part of the gaming machine. The cooling space 4 extends in the vertical direction almost over the whole height of the gaming machine.

The inlet opening 5 of the cooling space 4 is arranged in the upper part of the gaming machine and the outlet opening 6 of the cooling space 4 is arranged in the lower part of the gaming machine. In this embodiment, the air circulation is based on gravitation.

The processor space 2 can be arranged in the lower part of the gaming machine, for instance below the level of the push-button panel 6. The hot air from the processor space 2 can flow between the partition wall 8 and the display 17 to the upper part of the gaming machine. The hot air is then introduced into the cooling space 4 via the inlet opening 5. In the cooling space 4, the air flows in contact with the cooling wall 7 to the lower end of the cooling space 4 and is discharged via the outlet opening 6 of the cooling space 4. Because the cooling space 4 and the cooling wall 7 extend almost over the whole height of the gaming machine, the surface area of the cooling wall 7 is large, thus facilitating effective cooling of the air in the cooling space 4. Also the flow path of the air is long. In a gaming machine shown in FIGS. 7 to 12, the length of the flow path of the air from the inlet opening 5 to the outlet opening 6 of the cooling space 4 can be, for example, at least 70 percent of the height of the gaming machine.

In the embodiment of FIGS. 7 to 12, the lower part of the housing can comprise a larger space forming the processor space 2. The processor space 2 can thus accommodate also many other components than a processing unit 3.

In the embodiment of FIGS. 7 to 12, the gaming machine comprises support rails 15 arranged between the partition wall 8 and the cooling wall 7. The support rails 15 extend in the vertical direction of the cooling space 4. The support rails 15 stiffen the structure. The support rails 15 can be made of aluminum or aluminum alloy. This facilitates heat conduction from the partition wall 8 to the cooling wall 7.

In the embodiment of FIGS. 7 to 12, the inlet and outlet openings 5, 6 of the cooling space 4 are made large in the lateral direction of the gaming machine. This facilitates effective flow of cooling air. Instead of a single inlet opening 5 and a single outlet opening 6, the gaming machine could comprise two or more inlet openings 5 and/or outlet openings 6. The width of a single inlet/outlet opening 5, 6 or the combined width of the inlet/outlet openings 5, 6 could be at least 70 percent of the width of the cooling wall 7 in the lateral direction of the gaming machine.

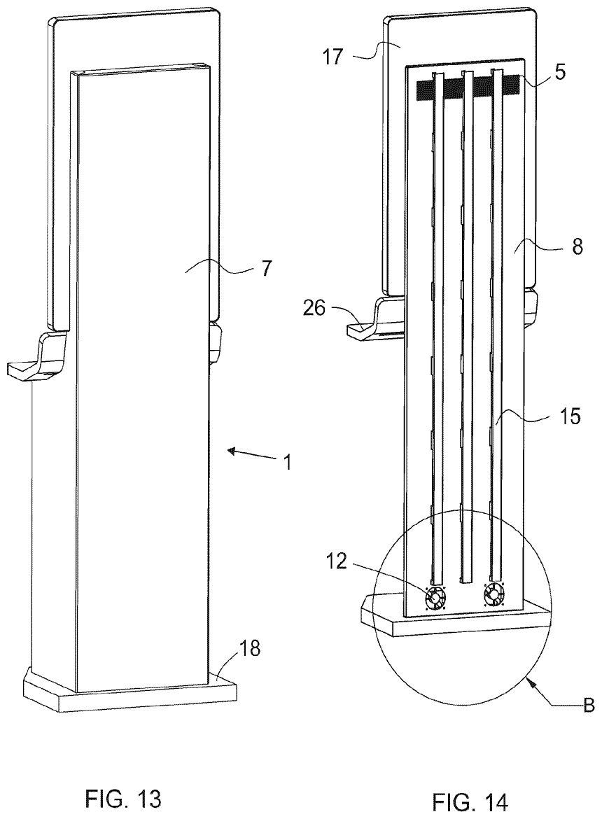

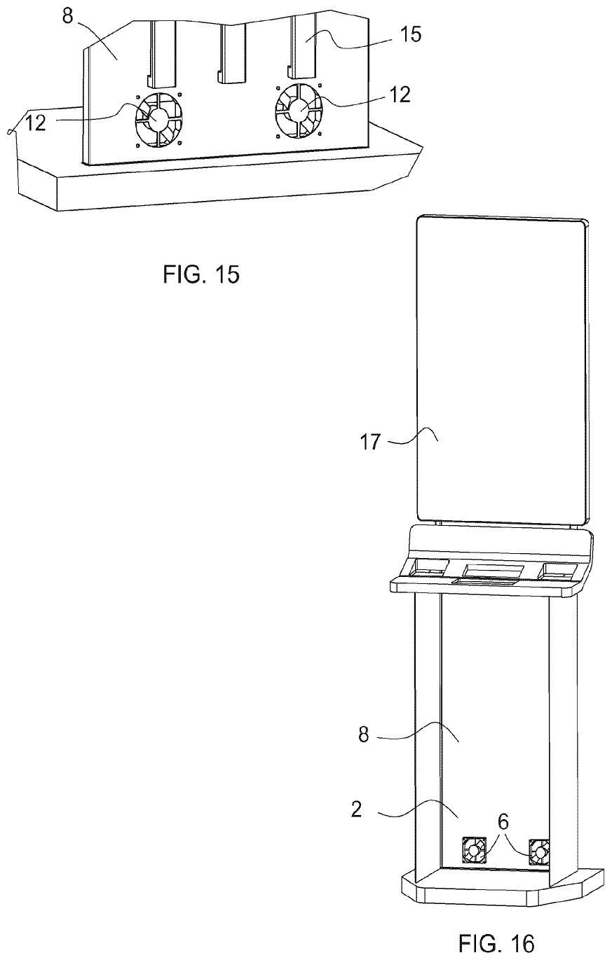

The embodiment of FIGS. 13 to 16 is similar to the embodiment of FIGS. 7 to 12. However, in this embodiment the gaming machine is provided with two cooling fans 12. The cooling fans 12 are arranged in the lower part of the gaming machine to discharge air from the cooling space 4 into the processor space 2. The cooling space 4 is also provided with two outlet openings 6. The number of the outlet openings 6 and cooling fans 12 could be different, and in addition to or instead of the cooling fans 12 arranged in the lower part of the gaming machine, the gaming machine could be provided with cooling fans arranged in the upper part of the gaming machine to introduce air into the cooling space 4. Also in this embodiment, the cooling fans 12 can be thermostat-controlled, or they can be configured to function whenever the gaming machine is switched on.

The embodiment of FIGS. 13 to 16 could be modified by arranging both the inlet opening 5 and the outlet opening 6 of the cooling space 4 at the upper end or the lower end of the cooling space 4 and by providing the cooling space 4 with one or more guide elements similar to the guide elements of the embodiment of FIGS. 1 to 6 to guide the air flow in the cooling space 4. This would provide an even longer flow path for the air.

In the embodiments of FIGS. 7 to 16, the cross-sectional profile of the gaming machine seen in the vertical direction is substantially rectangular. However, a similar high cooling space 4 as in the embodiments of FIGS. 7 to 16 could also be used in a gaming machine having some other shape. The cross-sectional profile of the housing 1 could thus be, for instance, circular. Also, the cooling wall 7 does not need to be planar, but it could be, for instance, curved.

It will be appreciated by a person skilled in the art that the invention is not limited to the embodiments described above, but may vary within the scope of the appended claims.

1. A gaming machine comprising:
a housing:
at least one processing unit;
a processor space arranged within the housing and accommodating the at least one processing unit of the gaming machine; and
a cooling space arranged within the housing, the cooling space comprising:
at least one inlet opening configured to allow air to pass from the processor space into the cooling space, and
at least one outlet opening configured to allow air that has cooled down in the cooling space to pass back into the processor space,
wherein the cooling space is delimited by a cooling wall that is configured to dissipate heat from the cooling space to outside of the cooling space, and the gaming machine is configured such that air introduced from the processor space into the cooling space flows in contact with the cooling wall before returning into the processor space.

2. The gaming machine according to claim 1, wherein the cooling space is configured such that a length of a flow path of air from the at least one inlet opening to the at least one outlet opening is at least 70 percent of a height of the gaming machine.

3. The gaming machine according to claim 1, wherein at least part of the cooling wall forms a portion of an outer wall of the gaming machine.

4. The gaming machine according to claim 3, wherein the cooling wall forms at least 35 percent of a rear wall of the gaming machine.

5. The gaming machine according to claim 1, wherein the cooling wall comprises a material having a thermal conductivity of at least 80 W/(m·K) at atmospheric pressure and temperature of 20° C.

6. The gaming machine according to claim 1, wherein the cooling wall comprises one of aluminum er and aluminum alloy.

7. The gaming machine according to claim 1, wherein the at least one inlet opening of the cooling space is arranged in a vertical direction above the at least one outlet opening.

8. The gaming machine according to claim 1, wherein the gaming machine further comprises:
a partition wall separating the cooling space from another part of an interior of the housing; and
a power source attached to the partition wall outside of the cooling space.

9. The gaming machine according to claim 8, wherein the partition wall comprises an opening and the power source is attached to the partition wall by a mounting plate comprising cooling fins on a side of the mounting plate that faces the cooling space, so as to dissipate heat into the air in the cooling space.

10. The gaming machine according to claim 1, wherein the gaming machine comprises at least one cooling fan that is configured to introduce air into the cooling space.

11. The gaming machine according to claim 1, wherein the gaming machine comprises at least one cooling fan that is configured to discharge air from the cooling space.

12. The gaming machine according to claim 10, wherein the at least one cooling fan is thermostat-controlled.

13. The gaming machine according to claim 1, wherein the gaming machine further comprises one or more guide elements configured to guide air flow in the cooling space.

14. The gaming machine according to claim 13, wherein said one or more guide elements are configured to divide the cooling space into at least two compartments to increase a length of a flow path of air between the inlet opening and the outlet opening.

15. The gaming machine according to claim 1, wherein the gaming machine further comprises at least one support rail connecting the cooling wall of the cooling space to a parallel partition wall separating the cooling space from another part of an interior of the gaming machine.

16. The gaming machine according to claim 2, wherein at least part of the cooling wall forms a portion of an outer wall of the gaming machine.

17. The gaming machine according to claim 16, wherein the cooling wall forms at least 35 percent of a rear wall of the gaming machine.

18. The gaming machine according to claim 17, wherein the cooling wall comprises a material having a thermal conductivity of at least 80 W/(m·K) at atmospheric pressure and temperature of 20° C.

19. The gaming machine according to claim 5, wherein the cooling wall comprises a material having a thermal conductivity of at least 150 W/(m·K) at atmospheric pressure and temperature of 20° C.

20. The gaming machine according to claim 18, wherein the cooling wall comprises a material having a thermal conductivity of at least 150 W/(m·K) at atmospheric pressure and temperature of 20° C.
